(19) United States
(12) Patent Application Publication
(10) Pub. No.: US 2016/0029279 A1
(43) Pub. Date: Jan. 28, 2016

(54) Wireless Communication Handover Profiles

(71) Applicant: GOOGLE TECHNOLOGY HOLDINGS LLC, Mountain View, CA (US)

(72) Inventors: Krishna K. Bellamkonda, Lake Zurich, IL (US); Jing Ji, Gurnee, IL (US); Nischal Y. Patel, Gilberts, IL (US); Brett L. Robertson, Mundelein, IL (US); Sudhir C. Vissa, Bensenville, IL (US); Hui Wang, Gurnee, IL (US)

(21) Appl. No.: 14/337,292

(22) Filed: Jul. 22, 2014

(51) Int. Cl. H04W 36/24

(52) U.S. Cl. CPC H04W 36/24

(57) ABSTRACT

In embodiments of wireless communication handover profiles, a profile manager is implemented on a communication-enabled device to detect that a signal strength of a wireless connection decreases to a signal-level threshold or lower. The profile manager then monitors the decreasing signal strength of the wireless connection, and compares the signal strength to a handover profile to determine when a handover of the wireless connection from one access point to another will likely occur. The profile manager can then transfer handover parameters to the next access point before the handover to maintain the wireless connection during the handover between the access points.

### BACKGROUND

Portable, communication-enabled devices, such as cell phones, can generally establish wireless connections via many different communication networks. For example, a cell phone can be used over WiFi or other short-range wireless network, such as for a Voice-over-Internet-Protocol (VoIP) wireless connection, and the cell phone can also be used over a cellular network. Many modern phone devices support several radio access technologies, such as Bluetooth™ and WiFi, as well as 3G, 4G, and/or LTE cellular communication technologies. In some use cases, a handover from one communication network to another (e.g., a heterogeneous network using different connection technologies), or a handover within the same network (e.g., a homogeneous network), is needed to maintain a wireless connection for a device. For example, a user may initiate a phone call with a cell phone that is initially connected over WiFi, such as in a home or office setting where the user has local network access. While on the phone call, the user may then transition to a vehicle or otherwise out of range of the local network, and the phone call is handed over to a cellular network to maintain the wireless connection and not drop the call.

Wireless connection handovers between cells within the same cellular network (e.g., having the same radio access technology) are primarily driven by network configuration and common standards. However, handovers between WiFi and 4G, for instance, are poorly handled and can cause data disruptions, VoIP session drops, and generally a poor user experience. The radio conditions at the time of a handover between short-range wireless networks, such as WiFi or other personal area networks (PANs), and wide-range wireless networks, such as cellular networks, are not properly taken into account. Primarily, the radio conditions for short-range wireless networks are subject to limitations, such as being mostly ad hoc in their layout; operating in unlicensed bands with unpredictable interference; no accounting for cell planning methodologies for technologies such as WiFi, Bluetooth™, and the Zigbee™ wireless standard; and having propagation characteristics for 2.4G and 5G access points for the same wireless network.

### BRIEF DESCRIPTION OF THE DRAWINGS

Embodiments of wireless communication handover profiles are described with reference to the following Figures. The same numbers may be used throughout to reference like features and components that are shown in the Figures:

FIG. 1 illustrates an example system in which embodiments of wireless communication handover profiles can be implemented.

FIG. 2 illustrates an example method of wireless communication handover profiles in accordance with one or more embodiments.

FIG. 3 illustrates another example method of wireless communication handover profiles in accordance with one or more embodiments.

FIG. 4 illustrates another example method of wireless communication handover profiles in accordance with one or more embodiments.

FIG. 5 illustrates various components of an example electronic device that can implement embodiments of wireless communication handover profiles.

### DETAILED DESCRIPTION

Embodiments of wireless communication handover profiles are described, and provide techniques that focus on how to prepare for a handover from one communication network to another (e.g., a heterogeneous network using different connection technologies), or prepare for a handover within the same network (e.g., a homogeneous network). The techniques are implemented so as to maintain a wireless connection without delay and/or so as not to drop a call for a device when transferring the connection between different networks or between access points in the same network.

The techniques for wireless communication handover profiles provide a fundamental change in the way that handover thresholds are determined by monitoring deteriorating radio signal characteristics and customizing network handover parameters. In embodiments, a communication-enabled device, such as a mobile phone, can implement a profile manager to detect when the signal strength of a wireless connection decreases to a signal-level threshold or lower. The profile manager then monitors the decreasing signal strength of the wireless connection, and compares the signal strength to a handover profile to determine when a handover of the wireless connection from one access point to another will likely occur. The profile manager can then transfer handover parameters to the next access point before the handover to maintain a wireless connection during the handover between the access points.

The communication-enabled device may have a wireless connection established via an access point of an unmanaged wireless network, and the wireless connection is handed over to an access point of a managed wireless network. The unmanaged wireless network may be a WiFi network or personal area network for VOIP communication, and the managed wireless network is a cellular network for wireless communication. The profile manager transfers the handover parameters to the managed wireless network before the handover to avoid the unmanaged wireless network dropping the wireless connection.

Alternatively, the access points may be within the same wireless communication network, and the profile manager transfers the handover parameters within the wireless communication network before the handover to avoid dropping the wireless connection. For example, the profile manager can be implemented to manage monitored networks, such as cellular (4G, 3G) that may encounter data stalls or persistent handover failures in a specific location. This location information can also be shared with a cloud-based service, and used to provide warnings to others in an area where data stalls and/or handover failures frequently occur. The profile manager that is implemented by a communication-enabled device can monitor cellular handovers where failures were encountered and alter the signal level thresholds, irrespective of the network mandated thresholds. Additionally, if certain cells are found to be disruptive, the profile manager can create a blacklist of cells which are not conducive for maintaining communication.

The profile manager is implemented to determine wireless connection signal degradation and signal migration between access points, and then customize the handover for a particular access point and communication-enabled device per location and time of day. When transitioning from one type of a network to another, signal level drops at handover transition points can be specific to particular access points and the environment, and the handover can be customized based on how the wireless connection signal degrades before it disconnects. A history is then established as to how a communication-enabled device exits from a particular access point, and access point exit patterns are determined. For example, the profile manager can aggregate the signal connection metrics every four hours (or over other durations of time) to capture the transient trends when a communication-enabled device is connected for wireless communication via an access point. In implementations, the communication evaluation methodology takes into account the connectivity success rate with a captive portal to determine the latency encountered for connections over a communication link of the transmission and reception data rates on the interface for the monitored duration. These metrics can be collected by the profile manager of a communication-enabled device when tasked with monitoring the connections.

A handover profile of a communication-enabled device can be generated based on metrics that include, but are not limited to, the signal-level threshold that indicates when to begin monitoring the signal strength of a wireless connection; a disconnect duration of time that it takes for the communication-enabled device to disconnect the wireless connection from the access point; and signal-level samples of the signal strength of the wireless connection during the disconnect duration. Further, the handover profile of a communication-enabled device can be generated based on communication-connection metrics associated with wireless communications over a period of one or more days or one or more weeks. The profile manager can determine and re-adjust the signal-level threshold in connection with entry and exit criterion of a handover disconnect duration to adapt to the dynamic

In embodiments, the profile manager of a communication-enabled device can upload some of the communication-connection metrics to a cloud-based service that aggregates metrics from multiple communication-enabled devices to generate handover profiles for particular access points and/or location-based handover profiles. The cloud-based service can also maintain the handover profiles of multiple access points and/or locations that may be requested from a communication-enabled device. The crowd-sourced database of handover patterns, as well as the parameters and radio access technologies, that are aggregated per location based on frequency band, time of the day, and day of the week can be used to determine baselines for locations, and a communication-enabled device can utilize the location baselines to customize and establish connection exposure to the various networks.

The profile manager of the communication-enabled device can receive the handover profiles of the multiple access points and/or locations from the cloud-based service, and can then identify a best communication-connection option for the device in a particular area or at a particular location based on the handover profiles. In implementations, the location-based handover profiles can be determined over a square kilometer or other defined area, and the profile manager determines the best connectivity option in a particular area based on the data that is aggregated per location, such as to determine blind spots in coverage. For example, a user may be walking while on a cell phone call and turn a corner, which unexpectedly drops the call.

While features and concepts of wireless communication handover profiles can be implemented in any number of different devices, systems, environments, and/or configurations, embodiments of wireless communication handover profiles are described in the context of the following example devices, systems, and methods.

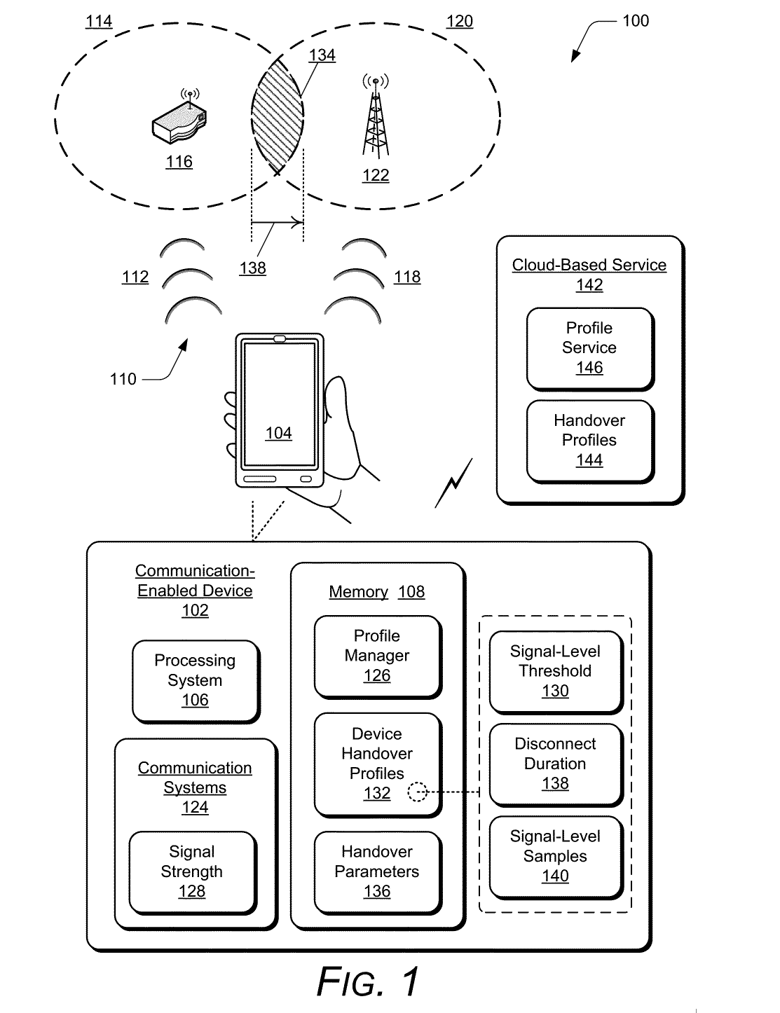

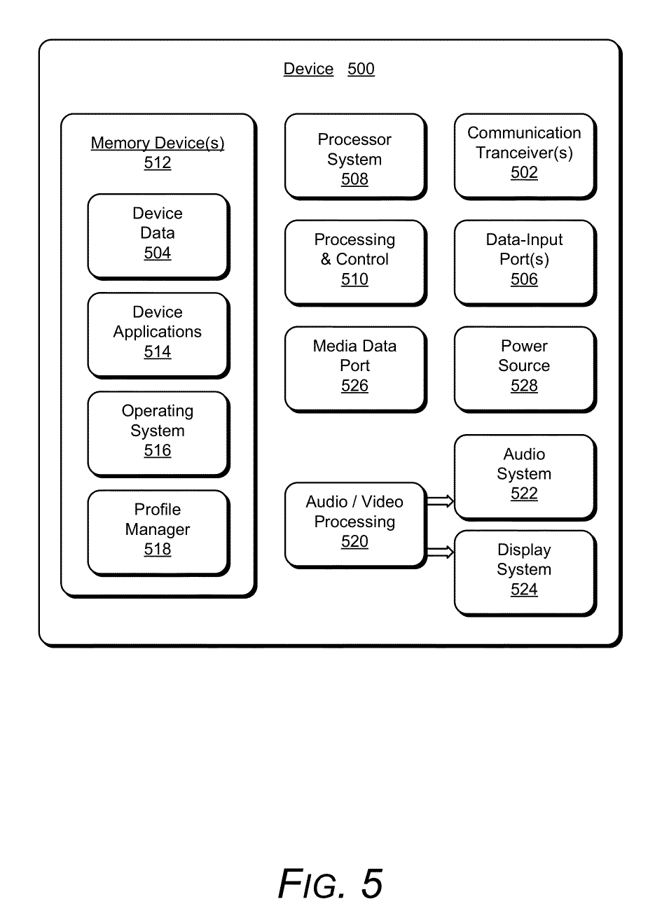

FIG. 1 illustrates an example system 100 in which embodiments of wireless communication handover profiles can be implemented. The example system 100 includes a communication-enabled device 102, such as a mobile phone 104 or any other tablet, media playback, computing, gaming, entertainment, and/or electronic media device that is implemented for data and/or voice communication. The communication-enabled device 102 can be implemented with various components, such as a processing system 106 and memory 108, and with any number and combination of differing components as further described with reference to the example device shown in FIG. 5.

The mobile phone 104 (e.g., as an example of the communication-enabled device 102) can establish a wireless connection 110 as a wireless Internet connection 112 over a WiFi or other short-range wireless network 114 via an access point 116 that is managed by an Internet service provider (ISP), such as for Voice-over-Internet-Protocol (VoIP) communications. The mobile phone 104 can also establish the wireless connection 110 as a wireless cellular connection 118 over a cellular network 120 via an access point 122 that is managed by a cell phone provider for wireless communications. The communication-enabled device 102 includes one or more communication systems 124 that can be implemented to support several radio access technologies, such as Bluetooth™ and WiFi, as well as 3G, 4G, and/or LTE cellular communication technologies.

The communication-enabled device 102 includes a profile manager 126 that can be implemented as a software application or module, such as executable software instructions (e.g., computer-executable instructions) that are executable with the processing system 106 of the computing device to implement embodiments of wireless communication handover profiles. The profile manager 126 can be stored on computer-readable storage media, such as any suitable memory device or electronic data storage implemented by the computing device.

In embodiments, the profile manager 126 is implemented to detect when the signal strength 128 of the wireless connection 110 decreases to a signal-level threshold 130 or lower. The profile manager 126 then monitors the decreasing signal strength of the wireless communication, and compares the signal strength 128 to a handover profile 132 to determine when a handover 134 of the wireless connection 110 from the access point 116 to the access point 122 will likely occur. The profile manager 126 can then transfer handover parameters 136 to the next access point 122 before the handover 134 to maintain the wireless connection 110 during the handover between the access points. The handover 134 of the wireless connection can be completed without a delay and so as not to drop the wireless call or data connection.

As shown in the example system 100, the communication-enabled device 102 may have the wireless connection 110 established via the access point 116 of an unmanaged wireless network (e.g., the WiFi or other short-range wireless network 114), and the wireless connection is handed over to the access point 122 of a managed wireless network (e.g., the cellular network 120 or other long-range wireless network). The profile manager 126 transfers the handover parameters 136 to the managed wireless network before the handover 134 to avoid the unmanaged wireless network dropping the wireless connection.

Alternatively, the access points 116 and 122 may be within the same wireless communication network, and the profile manager 126 transfers the handover parameters 136 within the wireless communication network before the handover 134 to avoid dropping the wireless connection. For example, the profile manager can be implemented to manage monitored networks, such as cellular (4G, 3G) that may encounter data stalls or persistent handover failures in a specific location. This location information can also be shared with a cloud-based service, and used to provide warnings to others in an area where data stalls and/or handover failures frequently occur. The profile manager that is implemented by a communication-enabled device can monitor cellular handovers where failures were encountered and alter the signal level thresholds, irrespective of the network mandated thresholds. Additionally, if certain cells are found to be disruptive, the profile manager can create a blacklist of cells which are not conducive for maintaining communication.

The handover profile 132 of the communication-enabled device 102 can be generated based on metrics that include, but are not limited to, the signal-level threshold 130 that indicates when to begin monitoring the signal strength 128 of the wireless connection; a disconnect duration 138 of time that it takes for the communication-enabled device 102 to disconnect the wireless connection 110 from the access point 116; and signal-level samples 140 of the signal strength of the wireless connection during the disconnect duration.

The profile manager 126 is implemented to characterize the drop in signal levels and quality, such as for the short-range wireless network 114 from an operational range to a non-operational range (e.g., also referred to as a noise floor). Part of the characterization is to determine the disconnect and roaming scenarios for the wireless network in operation. The characterization boundaries include a unique identifier such as basic service set identification (BSSID), channel, geolocation envelope, time of the day, and day of the week. The profile manager 126 captures the unique characteristics of the wireless access point 116 that is operating in a specific frequency band at a specific location, and profiles this behavior based on transient trends which include user-traffic, change in radio interference, and so on. The characterization collection techniques can be based on the sample size, based on time bounds, or can be event-based, such as for disruptions and/or data stalls in a well-known geolocation grid. The profile manager 126 can also be implemented to take into account the wireless capabilities of the communication-enabled devices, the parameters of which are exchanged with an access point as part of a wireless connection. Other factors that may be considered include lease times from access points, such as lease renewals that are issued by the access points for a duration of time (e.g., 48 hours, 72 hours, etc.). The profile manager can also consider any MAC address (e.g., device, WiFi, hardware address, etc.) for specific control managed by an access point, such as attributes that include an allow list, a block or blacklist, and Internet traffic allotted time.

The profile manager 126 can also be implemented to predict the slope of signal-level deterioration when collecting the signal-level samples between the entry and exit criterion of the handover 134. Based on the received samples, the profile manager can calculate the slope (e.g., linear or otherwise) and given at least five samples, can develop a prediction algorithm having two signal levels and an amount of time that it takes to deteriorate to no-connectivity. The profile manager chronicles the signal-level deterioration to obtain enough data to predict the change in signal levels. Additionally, dynamic changes to the entry and exit thresholds of the handover 134 may encounter drastic signal-level deterioration, and the entry threshold of a disconnect, roaming, or data stall event is not captured. For instance, a user may encounter an RF hole with no sufficient measurements for the particular access point or the cell. The profile manager 126 can then make adjustments to the entry threshold to obtain more data points, such as by setting the data sample threshold to five, and if the entry threshold and monitoring does not yield N-data samples, or is not within a set time duration, the entry threshold can be modified to accommodate more data points. Further, the entry and exit criterion of the handover 134 can be customized to handle the dynamic changes to the thresholds per WLAN chipset and model (e.g., processor type), per antenna type, and/or based on any other scalable, flexible factor across the communication-enabled devices.

Further, the handover profile 132 of the communication-enabled device 102 can be generated based on communication-connection metrics associated with wireless communications over a period of one or more days or one or more weeks, and for wireless connections that disconnect due to data stalls or user intervention. The profile manager 126 can determine and re-adjust the signal-level threshold 130 in connection with entry and exit criterion of the handover disconnect duration 138 (e.g., also shown as the overlap region between the two networks) to adapt to the dynamic nature of radio propagation characteristics that the communication-enabled device may encounter.

For wireless communications, such as the wireless connection 110 between the mobile phone 104 and the wireless access point 116, the profile manager 126 can establish initial parameters that include a session identifier that associates the mobile phone 104 and the wireless access point 116 for a current wireless connection. The profile manager 126 can detect when the signal strength 128 of the wireless connection 110 decreases to a signal-level threshold 130 or lower, and begin characterization of the particular wireless connection. The profile manager 126 then monitors the signal strength of the wireless connection and generates a signal array of aggregated signal samples.

In implementations, the communication evaluation methodology takes into account the connectivity success rate with a captive portal to determine the latency encountered for connections over a communication link of the transmission and reception data rates on the interface for the monitored duration. These metrics can be collected by the profile manager of a communication-enabled device when tasked with monitoring the connections. The profile manager 126 can aggregate communication-connection metrics per geohash for disconnects and data stalls, and the metrics include the time of day, day of the week, a session list per session identifier, an exit threshold of the handover 134, an average duration of the disconnect duration 138, an average of the signal strength 128, the entry signal-level threshold 130 of the handover 134, and an indication as to the connectivity status of the Internet. The profile manager 126 also aggregates metrics for a geolocation, and the metrics include a geohash grid, the time of day, day of the week, and the device platform (e.g., of the mobile phone 104). The profile manager 126 also aggregates the metrics for the communication-enabled device, and the metrics include the session identifier, the duration of the handover 134, a sample count of the signal strength samples, a disconnect code that indicates a reason for disconnection of the wireless connection 110, the entry signal-level threshold 130 of the handover 134, an exit condition of the handover, and the signal array of the aggregated signal samples.

The example system 100 also includes a cloud-based service 142 that can be accessed by computing devices, such as the communication-enabled device 102 and the mobile phone 104. The cloud-based service 142 includes network-based data storage of handover profiles 144 that are access-point handover profiles and/or location-based handover profiles. The cloud-based service 142 can also include one or multiple hardware server devices and applications, and can be implemented with various components, such as a processing system and memory, as well as with any number and combination of differing components as further described with reference to the example device shown in FIG. 5.

The cloud-based service 142 implements a profile service 146 as a software application or module, such as software instructions that are executable with a processing system of the cloud-based service to implement embodiments of wireless communication handover profiles. In embodiments, the profile manager 126 of the communication-enabled device 102 can upload some of the communication-connection metrics to the cloud-based service 142, and the profile service 146 aggregates the metrics from multiple communication-enabled devices to generate the handover profiles 144 of particular access points and/or for particular locations.

The cloud-based service 142 maintains the handover profiles 144 of multiple access points and locations, and the handover profiles may be requested by the communication-enabled device 102. The crowd-sourced database of handover profiles, as well as the parameters and radio access technologies, that are aggregated per location based on frequency band, time of the day, and day of the week, can be used to determine baselines for locations. The communication-enabled device 102 can utilize the location baselines to customize and establish connection exposure to the various networks. For example, the profile manager 126 of the communication-enabled device 102 can receive the handover profiles 144 of the multiple access points from the cloud-based service 142, and can then identify a best communication-connection option for the device in a particular area based on the handover profiles of the multiple access points and/or locations.

The profile service 146 at the cloud-based service 142 can receive and aggregate the communication-connection metrics received from multiple communication-enabled devices. The metrics can include aggregated geolocation data per frequency band, platform, the radio access technology, the time of day, day of the week, session identifiers across all of the wireless connections, the exit threshold of the handover 134, the average duration of the disconnect duration 138, the average of the signal strength 128, the entry signal-level threshold 130 of the handover 134, and the indication as to the connectivity status of the Internet at the time of the disconnect.

Any of the devices, servers, and/or services described herein can communicate via one or more of the networks, such as for data communication between the communication-enabled device 102, the mobile phone 104, and the cloud-based service 142. The networks can be implemented to include a wired and/or a wireless network. The networks can also be implemented using any type of network topology and/or communication protocol, and can be represented or otherwise implemented as a combination of two or more networks, to include IP-based networks and/or the Internet. The network may also include mobile operator networks that are managed by a mobile network operator and/or other network operators, such as a communication service provider, mobile phone provider, and/or Internet service provider.

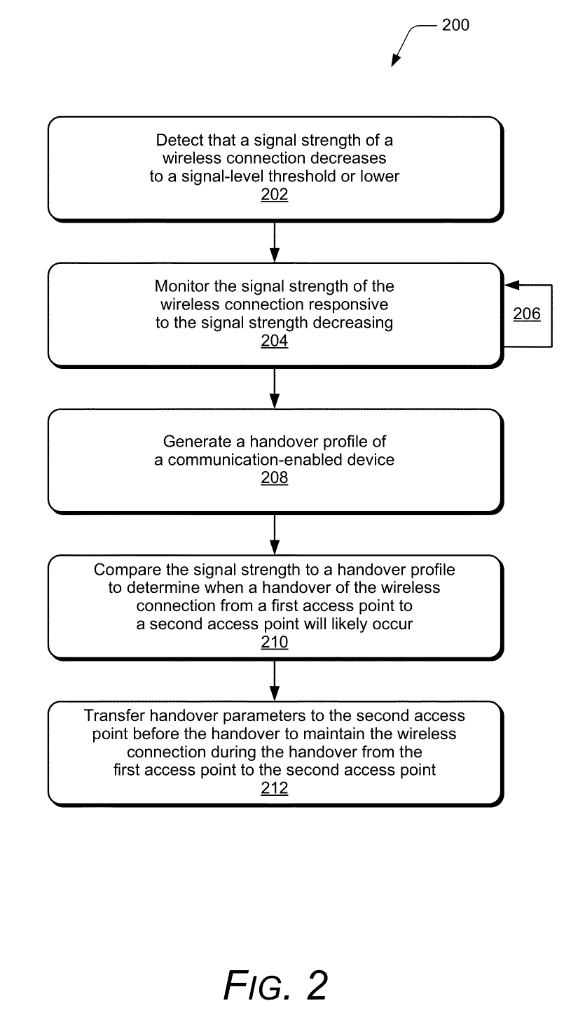

Example methods 200, 300, and 400 are described with reference to respective FIGS. 2, 3, and 4 in accordance with implementations of wireless communication handover profiles. Generally, any of the services, components, modules, methods, and operations described herein can be implemented using software, firmware, hardware (e.g., fixed logic circuitry), manual processing, or any combination thereof. The example methods may be described in the general context of executable instructions stored on computer-readable storage media that is local and/or remote to a computer processing system, and implementations can include software applications, programs, functions, and the like.

FIG. 2 illustrates example method(s) 200 of wireless communication handover profiles, and is generally described with reference to a communication-enabled device. The order in which the method is described is not intended to be construed as a limitation, and any number or combination of the described method operations can be performed in any order to perform a method, or an alternate method.

At 202, a signal strength of a wireless connection is detected as it decreases to a signal-level threshold or lower. For example, the profile manager 126 that is implemented by the mobile phone 104 (e.g., as an example of the communication-enabled device 102 shown in FIG. 1) detects when the signal strength 128 of the wireless connection 110 decreases to a signal-level threshold or lower.

At 204, the signal strength of the wireless connection is monitored responsive to the signal strength decreasing. For example, the profile manager 126 then monitors the signal strength 128 of the wireless connection 110 responsive to the signal strength 128 decreasing. At 206, the profile manager 126 continues to monitor and sample the signal strength of the wireless connection during the disconnect duration 138 of the handover 134.

At 208, a handover profile of a communication-enabled device is generated. For example, the profile manager 126 generates the handover profile 132 of the communication-enabled device 102, where the handover profile includes the signal-level threshold 130 that indicates when to begin monitoring the signal strength 128 of the wireless connection; the disconnect duration 138 of time that it takes for the communication-enabled device 102 to disconnect the wireless connection 110 from the access point 116; and signal-level samples 140 of the signal strength of the wireless connection during the disconnect duration. The handover profile 132 of the communication-enabled device 102 can be generated based on communication-connection metrics associated with wireless communications over a period of one or more days or one or more weeks, and for wireless connection that disconnect due to data stalls or user intervention.

At 210, the signal strength is compared to a handover profile to determine when a handover of the wireless connection from a first access point to a second access point will likely occur. For example, the profile manager 126 compares the signal strength 128 to the handover profile 132 to determine when a handover 134 of the wireless connection 110 from the access point 116 to the access point 122 will likely occur. In the example system 100 shown in FIG. 1, the communication-enabled device 102 has the wireless connection 110 established via the access point 116 of an unmanaged wireless network (e.g., the WiFi or other short-range wireless network 114), and the wireless connection is handed over to the access point 122 of the managed wireless network (e.g., the cellular network 120).

At 212, handover parameters are transferred to the second access point before the handover to maintain the wireless connection during the handover from the first access point to the second access point. For example, the profile manager 126 then transfers the handover parameters 136 to the next access point 122 before the handover 134 to maintain the wireless connection during the handover between the access points. The handover 134 of the wireless connection can be completed without a delay and so as not to drop the wireless call or a data connection. The profile manager 126 transfers the handover parameters 136 to the managed wireless network 120 before the handover 134 to avoid the unmanaged wireless network 114 dropping the wireless connection. Alternatively, the access points 116 and 122 may be within the same wireless communication network, and the profile manager 126 transfers the handover parameters 136 within the wireless communication network before the handover 134 to avoid dropping the wireless connection.

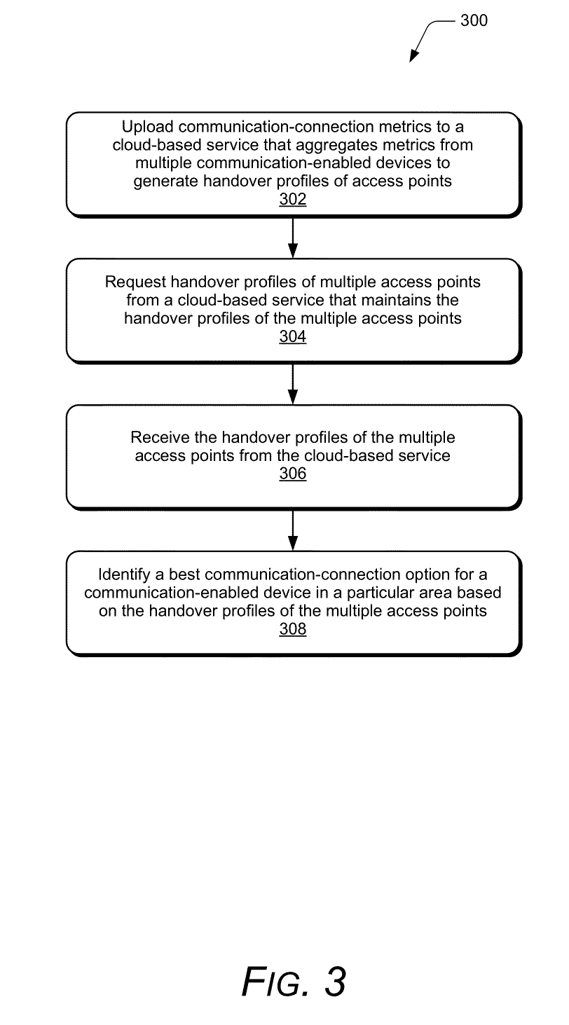

FIG. 3 illustrates example method(s) 300 of wireless communication handover profiles, and is generally described with reference to a communication-enabled device. The order in which the method is described is not intended to be construed as a limitation, and any number or combination of the described method operations can be performed in any order to perform a method, or an alternate method.

At 302, communication-connection metrics are uploaded to a cloud-based service that aggregates metrics from multiple communication-enabled devices to generate handover profiles of access points. For example, the profile manager 126 that is implemented by the communication-enabled device 102 uploads some of the communication-connection metrics to the cloud-based service 142, and the profile service 146 aggregates the metrics from multiple communication-enabled devices to generate the handover profiles 144 of particular access points and/or at particular locations.

At 304, handover profiles of multiple access points are requested from a cloud-based service that maintains the handover profiles of the multiple access points. At 306, the handover profiles of the multiple access points are received from the cloud-based service. For example, the communication-enabled device 102 requests and receives the handover profiles 144 from the cloud-based service 142.

At 308, a best communication-connection option is identified for a communication-enabled device in a particular area based on the handover profiles of the multiple access points. For example, the profile manager 126 then identifies a best communication-connection option for the communication-enabled device 102 in

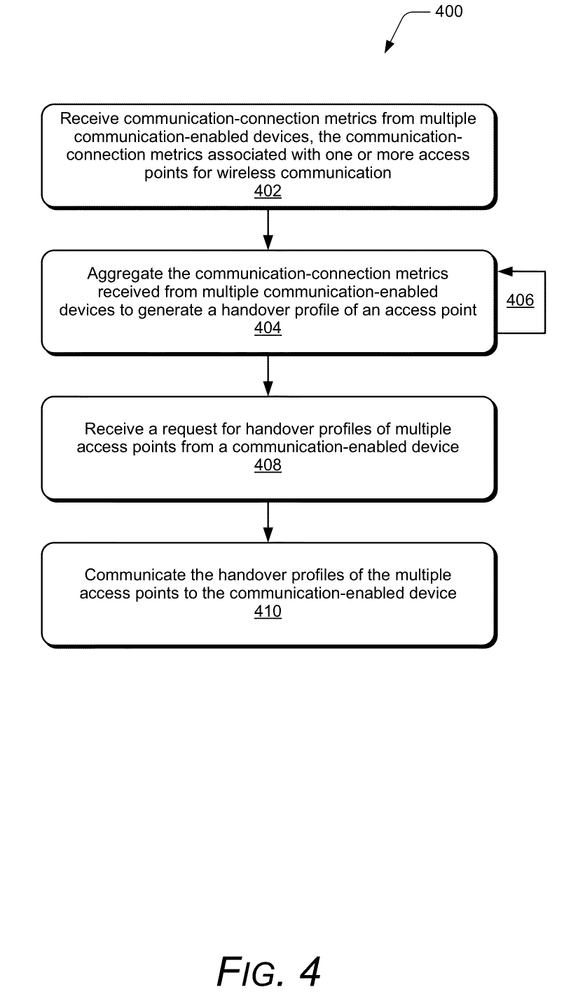

FIG. 4 illustrates example method(s) 400 of wireless communication handover profiles, and is generally described with reference to a cloud-based service. The order in which the method is described is not intended to be construed as a limitation, and any number or combination of the described method operations can be performed in any order to perform a method, or an alternate method.

At 402, communication-connection metrics are received from multiple communication-enabled devices, where the communication-connection metrics are associated with one or more access points for wireless communication. For example, the cloud-based service 142 receives communication-connection metrics from multiple communication-enabled devices, such as the communication-enabled device 102 and the mobile phone 104. The communication-connection metrics can be associated with one or more access points for wireless communication and/or locations and areas for wireless communication connections.

At 404, the communication-connection metrics received from multiple communication-enabled devices and corresponding to an access point are aggregated to generate a handover profile of the access point. For example, the profile service 146 that is implemented by the cloud-based service 142 aggregates the communication-connection metrics for an access point to generate a handover profile 144 of the access point. At 406, the profile service 146 continues to aggregate the communication-connection metrics for individual access points and/or particular locations to generate the handover profiles 144.

At 406, a request for handover profiles of multiple access points is received from a communication-enabled device. At 408, the handover profiles of the multiple access points are communicated to the communication-enabled device. For example, the cloud-based service 142 receives a request from the communication-enabled device 102 for the handover profiles 144 that correspond to particular access points and/or locations, and the cloud-based service 142 communicates the handover profiles 144 to the requesting device. The communication-enabled device 102 then utilizes the handover profiles to determine a best communication-connection option in a particular area.

FIG. 5 illustrates various components of an example device 500 that can be implemented as any communication-enabled device described with reference to any of the previous FIGS. 1-4. In embodiments, the example device 500 may be implemented as any one or combination of a communication, computer, playback, gaming, entertainment, mobile phone, tablet computing device, and/or wearable device.

The device 500 includes communication transceivers 502 that enable wireless transmission and reception of device data 504. The transceivers 502 can include radios compliant with various wireless personal-area-network standards, such as Institute of Electrical and Electronics Engineers (“IEEE”) 802.15 standards, Infrared Data Association standards, or wireless Universal Serial Bus standards, to name just a few. The communication transceivers 502 can also include wireless local-area-network radios compliant with any of the various IEEE 802.11 standards, wireless-wide-area-network radios for cellular telephony, and wireless-metropolitan-area-network radios compliant with various IEEE 802.15 standards. The transceivers connect to one or more antennas, such as integrated in the device.

The device 500 may also include one or more data input ports 506 via which any type of data, media content, and/or inputs can be received, such as user-selectable inputs, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to components, peripherals, or accessories such as microphones and/or cameras.

The device 500 includes a processor system 508 of one or more processors (e.g., any of microprocessors, controllers, and the like) and/or a processor and memory system (e.g., implemented in an SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware.

Alternatively or in addition, the device can be implemented with any one or combination of software, hardware, firmware, or fixed logic circuitry that is implemented in connection with processing and control circuits, which are generally identified at 510. Although not shown, the device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The device 500 also includes one or more memory devices 512 that enable data storage, examples of which include random access memory (RAM), non-volatile memory (e.g., read-only memory (ROM), flash memory, EPROM, EEPROM, etc.), and a disk storage device. A disk storage device may be implemented as any type of magnetic or optical storage device, such as a hard disk drive, a recordable and/or rewriteable disc, any type of a digital versatile disc (DVD), and the like. The device 500 may also include a mass storage media device.

A memory device 512 provides data storage mechanisms to store the device data 504, other types of information and/or data, and various device applications 514 (e.g., software applications). For example, an operating system 516 can be maintained as software instructions with a memory device and executed by the processor system 508. The device applications may also include a device manager, such as any form of a control application, software application, signal-processing and control module, code that is native to a particular device, a hardware abstraction layer for a particular device, and so on. The device may also include a profile manager 518 that implements embodiments of wireless communication handover profiles, such as when the device 500 is implemented as a communication-enabled device as described with reference to FIGS. 1-4.

The device 500 also includes an audio and/or video processing system 520 that generates audio data for an audio system 522 and/or generates display data for a display system 524. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 526. In implementations, the audio system and/or the display system are integrated components of the example device.

The device 500 can also include a power source 528, such as when the device is implemented as a portable device (e.g., a mobile phone). The power source may include a charging and/or power system, and can be implemented as a flexible strip battery, a rechargeable battery, a charged super-capacitor, and/or any other type of active or passive power source.

Although embodiments of wireless communication handover profiles have been described in language specific to features and/or methods, the subject of the appended claims is not necessarily limited to the specific features or methods described. Rather, the specific features and methods are disclosed as example implementations of wireless communication handover profiles.

1. A method, comprising:
detecting that a signal strength of a wireless connection decreases to a signal-level threshold or lower;
monitoring the signal strength of the wireless connection responsive to the signal strength decreasing;
comparing the signal strength to a handover profile to determine when a handover of the wireless connection from a first access point to a second access point will likely occur; and
transferring handover parameters to the second access point before the handover to maintain the wireless connection during the handover from the first access point to the second access point.

2. The method as recited in claim 1, wherein:
an unmanaged wireless network includes the first access point and a managed wireless network includes the second access point; and
said transferring the handover parameters to the managed wireless network before the handover to avoid the unmanaged wireless network dropping the wireless connection.

3. The method as recited in claim 1, wherein:
a wireless communication network includes the first and second access points; and
said transferring the handover parameters within the wireless communication network before the handover to avoid dropping the wireless connection.

4. The method as recited in claim 1, further comprising:
generating the handover profile of a communication-enabled device, the handover profile including:
the signal-level threshold that indicates when to begin said monitoring the signal strength of the wireless connection;
a disconnect duration of time that it takes for the communication-enabled device to disconnect the wireless connection from the first access point; and
signal-level samples of the signal strength of the wireless connection during the disconnect duration.

5. The method as recited in claim 4, wherein the handover profile of the communication-enabled device is generated based on communication-connection metrics associated with wireless connections over a period of one or more days or one or more weeks.

6. The method as recited in claim 5, further comprising:
uploading at least some of the communication-connection metrics to a cloud-based service that aggregates the communication-connection metrics from multiple communication-enabled devices to generate a handover profile of the first access point.

7. The method as recited in claim 1, further comprising:
requesting handover profiles of multiple access points from a cloud-based service that maintains the handover profiles of the multiple access points;
receiving the handover profiles of the multiple access points from the cloud-based service; and
identifying a best communication-connection option for a communication-enabled device in a particular area based on the handover profiles of the multiple access points.

8. A communication-enabled device, comprising:
a communication system configured for wireless communications;
a memory configured to maintain a handover profile of the communication-enabled device;
a processing system to implement a profile manager that is configured to:
detect that a signal strength of a wireless connection decreases to a signal-level threshold level or lower;
monitor the signal strength of the wireless connection responsive to the signal strength decreasing;
compare the signal strength to the handover profile to determine when a handover of the wireless connection will likely occur; and
transfer handover parameters before the handover to maintain the wireless connection during the handover.

9. The communication-enabled device as recited in claim 8, wherein the profile manager is configured to said transfer the handover parameters to a managed wireless network before the handover to avoid an unmanaged wireless network dropping the wireless connection.

10. The communication-enabled device as recited in claim 8, wherein the profile manager is configured to said transfer the handover parameters within a wireless network before the handover to avoid dropping the wireless connection.

11. The communication-enabled device as recited in claim 8, wherein the profile manager is configured to generate the handover profile of the communication-enabled device, the handover profile including:
the signal-level threshold that indicates when to begin monitoring the signal strength of the wireless connection;
a disconnect duration of time that it takes for the communication-enabled device to disconnect the wireless connection from an access point; and
signal-level samples of the signal strength of the wireless connection during the disconnect duration.

12. The communication-enabled device as recited in claim 8, wherein the handover profile of the communication-enabled device is generated based on communication-connection metrics associated with wireless connections over a period of one or more days or one or more weeks.

13. The communication-enabled device as recited in claim 12, wherein the profile manager is configured to upload at least some of the communication-connection metrics to a cloud-based service that aggregates the communication-connection metrics from multiple communication-enabled devices to generate a handover profile of an access point.

14. The communication-enabled device as recited in claim 8, wherein the profile manager is configured to:
request handover profiles of multiple access points from a cloud-based service that maintains the handover profiles of the multiple access points;
receive the handover profiles of the multiple access points from the cloud-based service; and
identify a best communication-connection option for the communication-enabled device in a particular area based on the handover profiles of the multiple access points.

15. A computer-readable storage memory comprising a profile manager stored as instructions that are executable and, responsive to execution of the instructions by a computing device, the computing device performs operations comprising to:
detect that a signal strength of a wireless connection decreases to a signal-level threshold level or lower;
monitor the signal strength of the wireless connection responsive to the signal strength decreasing;
compare the signal strength to a handover profile to determine when a handover of the wireless connection will likely occur; and
transfer handover parameters before the handover to maintain the wireless connection during the handover.

16. The computer-readable storage memory as recited in claim 15, wherein the computing device performs the operations of the profile manager further comprising to said transfer the handover parameters to a managed wireless network before the handover to avoid an unmanaged wireless network dropping the wireless connection.

17. The computer-readable storage memory as recited in claim 15, wherein the computing device performs the operations of the profile manager further comprising to said transfer the handover parameters within a wireless network before the handover to avoid dropping the wireless connection.

18. The computer-readable storage memory as recited in claim 15, wherein the computing device performs the operations of the profile manager further comprising to generate the handover profile of the computing device, the handover profile generated based on communication-connection metrics associated with wireless connections, and the handover profile including:
the signal-level threshold that indicates when to begin monitoring the signal strength of the wireless connection;
a disconnect duration of time that it takes for the computing device to disconnect the wireless connection from an access point; and
signal-level samples of the signal strength of the wireless connection during the disconnect duration.

19. The computer-readable storage memory as recited in claim 18, wherein the computing device performs the operations of the profile manager further comprising to upload at least some of the communication-connection metrics to a cloud-based service that aggregates the communication-connection metrics from multiple computing devices to generate a handover profile of an access point.

20. The computer-readable storage memory as recited in claim 15, wherein the computing device performs the operations of the profile manager further comprising to:
request handover profiles of multiple access points from a cloud-based service that maintains the handover profiles of the multiple access points;
receive the handover profiles of the multiple access points from the cloud-based service; and
identify a best communication-connection option for the computing device in a particular area based on the handover profiles of the multiple access points.
